(19) United States
(12) Patent Application Publication
(10) Pub. No.: US 2010/0302502 A1
(43) Pub. Date: Dec. 2, 2010

(54) GLASSES WITH ILLUMINATION FUNCTION

(75) Inventor: Pyung-Rae Ahn, Gyeonggi-do (KR)

Correspondence Address: FOLEY AND LARDNER LLP;SUITE 500, 3000 K STREET NW, WASHINGTON, DC, 20007, US

(73) Assignee: E-GUN Technology Co., Ltd., Seongnam-si, Gyeonggi-do (KR)

(21) Appl. No.: 12/674,268

(22) PCT Filed: Aug. 14, 2008
(86) PCT No.: PCT/KR08/04746

§ 371 Date: Mar. 25, 2010

(30) Foreign Application Priority Data
Aug. 20, 2007 (KR) 20-2007-0013762
Jan. 4, 2008 (KR) 20-2008-0000156
Aug. 8, 2008 (KR) 10-2008-0078018

(51) Int. Cl. G02C 11/04

(52) U.S. Cl. 351/158

(57) ABSTRACT

Eyeglasses with an illumination function include a frame having a pair of lenses mounted thereto. A pair of temples is collapsibly attached to the frame in a spaced-apart relationship with each other, each of the temples having a front end portion hingedly secured the frame, a rear end portion extending over each ear of a user and a forwardly opened receiving pocket formed in the front end portion. A plurality of lamps is received in the receiving pocket of each of the temples for emitting light forwards. A power source is provided independently of the frame and selectively connectable to the lamps via a cable.

### FIELD OF THE INVENTION

The present invention relates to eyeglasses with an illumination function and, more particularly, to eyeglasses in which lamps are provided in the temples thereof to realize an illumination function.

### BACKGROUND ART

Eyeglasses are a mechanism for use in correcting one's eyesight and protecting one's eyes. One example of the eyeglasses for correcting one's eyesight includes reading eyeglasses worn by a presbyope who cannot clearly see a nearby object. As an example of the safety eyeglasses for protecting one's eyes, there are sunglasses worn for the avoidance of sunlight or ultraviolet rays. Another example of the safety eyeglasses includes a goggle having unbreakable lenses, which is often worn for the protection of eyes when enjoying skiing, racing or other like sports. The eyeglasses mentioned above are essentially provided with a frame, a pair of lenses and a pair of temples.

At night or in dark places, there is a need to perform temporary illumination. Although a hand-held flashlight has been extensively used for the purpose of temporary illumination, it is difficult, if not impossible, for a user to carry the flashlight at all times. Furthermore, it is necessary for the user to hold the flashlight and shed the same on a target object, which imposes many restrictions on the activities of the user. Therefore, the flashlight is onerous and inconvenient to use.

U.S. Patent Publication No. 2007/0200998A1 discloses eyeglasses that perform illumination with light-emitting diodes. The eyeglasses disclosed in this patent document include a frame made of a transparent or translucent material and a light-emitting diode assembly with a plurality of light-emitting diodes built in the frame. The eyeglasses further include a pair of temples, one of which has a switch for controlling the supply of electric power to the light-emitting diodes and the other of which has a battery for supplying electric power to the light-emitting diodes when the switch is turned on.

Since the light-emitting diodes are built in the transparent or translucent frame according to the eyeglasses noted above, the light emitted from the light-emitting diodes is scattered to around the user's eyes while transmitting the frame and is reflected by the lenses. The light thus reflected reduces visibility and increases fatigue of the user's eyes, thereby adversely affecting the eyesight. Furthermore, the switch and the battery provided in the temples make the eyeglasses heavy and bulky. This causes inconvenience to the user in wearing the eyeglasses. In particular, the inability to manufacture the frame with metal or opaque plastic greatly reduces the degree of freedom in designing the eyeglasses.

### DETAILED DESCRIPTION OF THE INVENTION

### Technical Problems

In view of the above-noted and other problems inherent in the prior art, it is an object of the present invention to provide eyeglasses with an illumination function, which can improve visibility by allowing lamps attached to the front ends of temples to irradiate light forwardly in parallel with the viewing direction of a user.

Another object of the present invention is to provide eyeglasses with an illumination function, which are structurally simple, small-sized and lightweight, thanks to the provision of built-in type lamps attached to the front ends of temples.

A further object of the present invention is to provide eyeglasses with an illumination function, which make it possible to easily connect a power source provided independently of a frame to lamps through a cable.

### Solution to the Technical Problems

With these objects in view, there are provided eyeglasses with an illumination function, comprising: a frame having a pair of lenses mounted thereto; a pair of temples collapsibly attached to the frame in a spaced-apart relationship with each other, each of the temples having a front end portion hingedly secured the frame, a rear end portion extending over each ear of a user and a forwardly opened receiving pocket formed in the front end portion; a plurality of lamps received in the receiving pocket of each of the temples for emitting light forwards; and a power source provided independently of the frame and selectively connectable to the lamps via a cable.

### BRIEF DESCRIPTION OF THE DRAWINGS

FIG. 1 is a perspective view illustrating eyeglasses in accordance with a first embodiment of the present invention, which are worn by a user.

FIG. 2 is a perspective view showing the configuration of the eyeglasses in accordance with the first embodiment of the present invention.

FIG. 3 is a partial exploded perspective view of the eyeglasses of the first embodiment, with a holder, lamps and resistors dismantled from the eyeglasses.

FIG. 4 is a partial exploded perspective view of the eyeglasses of the first embodiment, with the holder and the lamps dismantled from the eyeglasses.

FIG. 5 is a partial sectional view of the eyeglasses of the first embodiment, with the holder and the lamps mounted to a receiving pocket.

FIG. 6 is a circuit diagram of the eyeglasses of the first embodiment including lamps, resistors and a power source.

FIG. 7 is a sectional view showing another example of a cable connection structure employed in the eyeglasses of the first embodiment.

FIG. 8 is a perspective view illustrating eyeglasses in accordance with a second embodiment of the present invention, which are worn by a user.

FIG. 9 is a perspective view showing the configuration of the eyeglasses in accordance with the second embodiment of the present invention.

FIG. 10 is a partial exploded perspective view of the eyeglasses of the first embodiment, with a holder and lamps dismantled from the eyeglasses.

FIG. 11 is a sectional view of the eyeglasses of the second embodiment, with the holder and the lamps mounted to a receiving pocket.

FIG. 12 is a circuit diagram of the eyeglasses of the second embodiment including lamps, a resistor and a power source.

FIG. 13 is a sectional view showing another example of a cable connection structure employed in the eyeglasses of the second embodiment.

FIG. 14 is a perspective view illustrating eyeglasses in accordance with a third embodiment of the present invention, which are worn by a user.

FIG. 15 is a sectional view showing an example of a cable connection structure employed in the eyeglasses of the third embodiment.

### BEST MODE FOR CARRYING OUT THE INVENTION

Hereinafter, preferred embodiments of eyeglasses with an illumination function in accordance with the present invention will be described in detail with reference to the accompanying drawings.

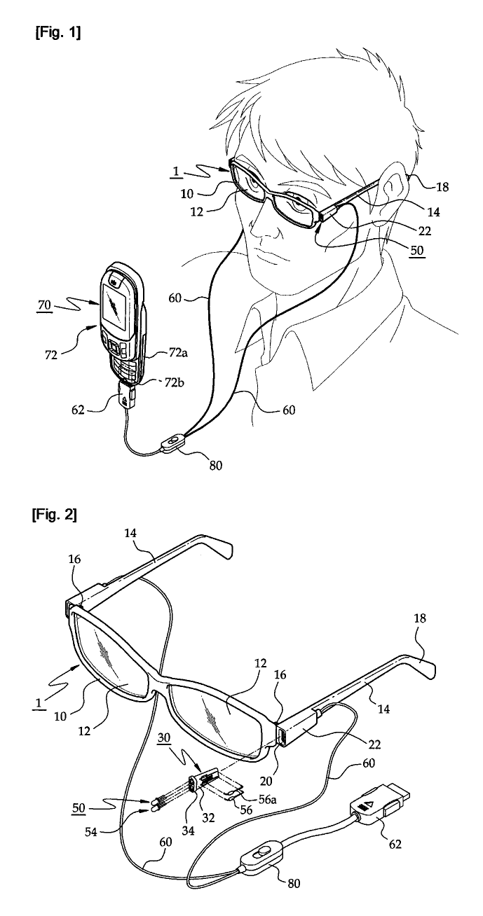

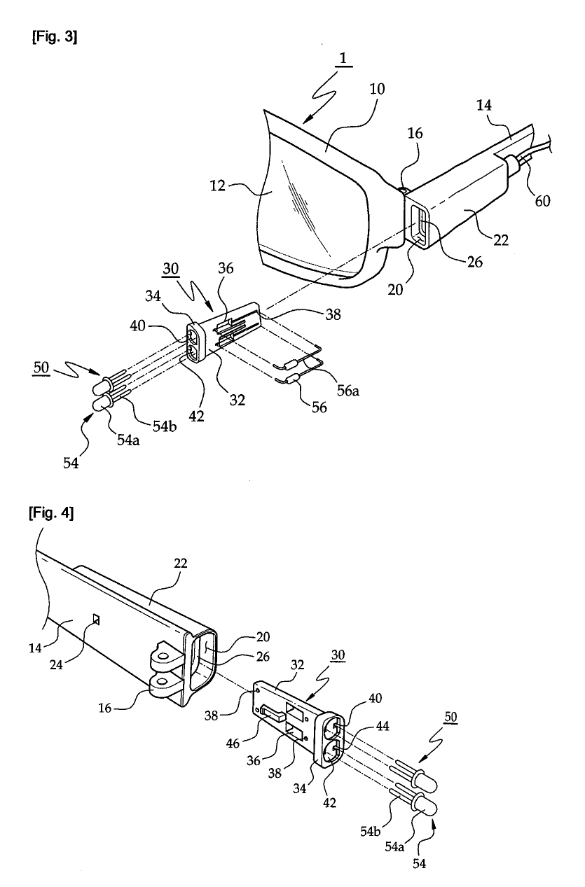

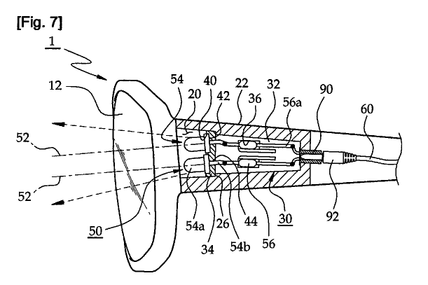

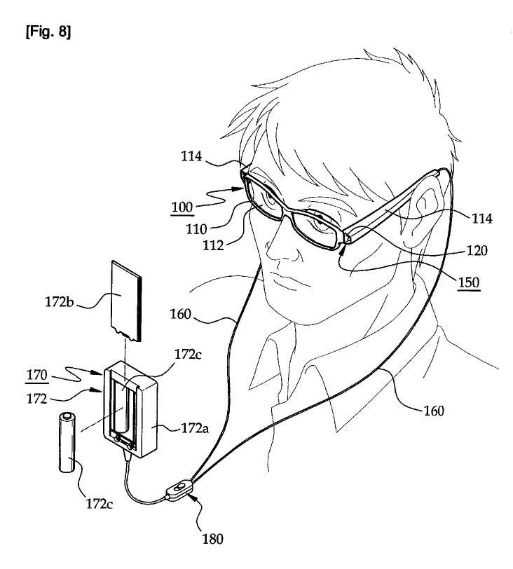

Shown in FIGS. 1 through 6 are eyeglasses with an illumination function in accordance with a first embodiment the present invention. Referring to FIGS. 1 and 2, the eyeglasses 1 include a frame 10, a pair of lenses 12 held by the frame 10 and a pair of temples 14 connected to the opposite lateral ends of the frame 10. Each of the temples 14 is collapsibly connected at its front end to the frame 10 by means of a hinge 16 and is provided with a rear tip 18 extending over either of the ears of a user.

Referring to FIGS. 1 through 4, each of the temples 14 includes a sheath 22 integrally formed at the front end thereof. The sheath 22 has a forwardly opened receiving pocket 20 and a locking hole 24 formed on the inner surface of each of the temples 14, the locking hole 24 communicating with the receiving pocket 20. The sheath 22 is formed on the outer surface of each of the temples 14 in an opposing relationship with the inner surface that makes contact with the user's skin. A shoulder 26 is formed inside the receiving pocket 20. On the rear surface of the sheath 22, there is formed a wiring hole 28 leading to the receiving pocket 20.

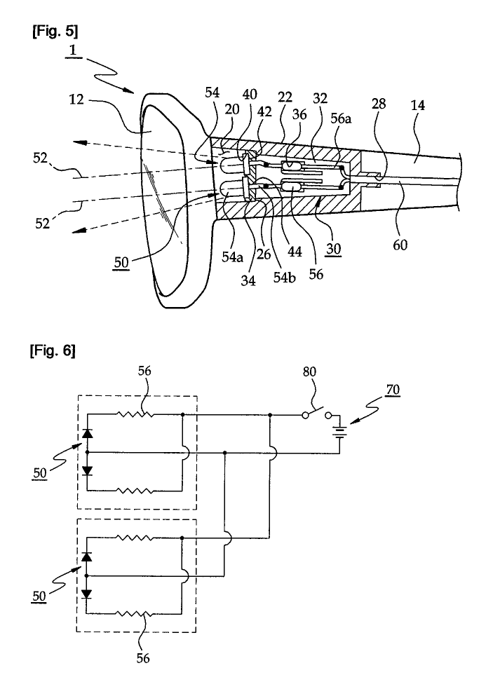

Referring to FIGS. 3 through 5, the eyeglasses 1 of the first embodiment further include holders 30 removably received within the receiving pockets 20 of the temples 14. Each of the holders 30 consists of a mounting plate portion fitted into the receiving pocket 20 and a flange 34 formed at the front end of the mounting plate portion 32. The mounting plate portion 32 is of a flat shape and has a plurality of fixing holes 36 and a plurality of through-holes 38. Furthermore, a plurality of fixing recesses 40 is formed on the front surface of each of the holders 30 near the flange 34. Each of the fixing recesses 40 terminates at a downwardly backwardly inclined support surface 42 on which a plurality of wiring holes 44 is formed. The flange 34 is supported at its rear peripheral edge by the shoulder 26 and is accurately self-aligned within the receiving pocket 20. A snap hook 46 is formed on one surface of the mounting plate portion 32. The snap hook 46 engages with the locking hole 24 of each of the temples 14, thereby preventing any inadvertent separation of each of the holder 30 from the receiving pocket 20.

The eyeglasses 1 of the first embodiment further include a plurality of lamps 50 mounted to the receiving pocket 20 of each of the holders 30. Each of the lamps 50 has a light axis 52 extending parallel to the line of sight of the user. Each of the lamps 50 is formed of a light-emitting diode 54 which consists of a body portion 54a for emitting light when energized and a plurality of leads 54b connected to the body portion 54a for supplying electric power thereto. The body portion 54a of the light-emitting diode 54 is received in each of the fixing recesses 40 and is supported by the inclined support surface 42 so that the light axis 52 of the light-emitting diode 54 can be kept parallel to the line of sight of the user. The leads 54b extend through the wiring holes 44.

Referring to FIGS. 3 through 6, a plurality of resistors 56 is fitted to the fixing holes 36 of each of the holders 30. The resistors 56 have leads 56a inserted into the through-holes 38. The leads 54b of the light-emitting diode 54 and the leads 56a of each of the resistors 56 are soldered to each other. While two lamps 50 and two resistors 56 are attached to each of the holders 30 in the first embodiment, this is for the purpose of illustration. The number of the lamps 50 and the resistors 56 may be lesser or greater, if such a need arises.

The lamps 50 are connected to a power source 70 via a cable 6 which extends toward the power source 70 through the wiring hole 28 of the sheath 22. The cable 60 is connected at its first end to the leads 56a of each of the resistors 56 and at its second end to a connector 62 serving as a power source connecting means. As shown in FIG. 1, the power source 70 may be a well-known mobile terminal 72 such as a mobile phone, a personal digital assistant, a portable multimedia player, an MP4 player or the like. The mobile terminal 72 includes a rechargeable battery 72a and a connection port 72b into which the connector 62 is connected. The power source 70 may be formed of a battery pack. As best shown in FIGS. 1, 2 and 6, a switch 80 for on-off controlling the supply of electric power is arranged in the cable 60 extending between the frame 10 and the power source 70.

In case where there is a need to perform illumination, the user wearing the eyeglasses 1 inserts the connector 62 into the connection port 72b of the mobile terminal 72 and then turns the switch 80 on. If the switch 80 is turned on, the electric power of the battery 72a of the mobile terminal 72 is supplied to the lamps 50 through the resistors 56.

In response, the lamps 50 are energized to emit light which in turn is irradiated forwards as illustrated in FIG. 5. The light of the lamps 50 is projected parallel to the line of sight of the user, thereby assuring increased visibility. This enables the user to definitely and clearly recognize a target object free from restraints in activity. The light-emitting diode 54 is highly durable, environmentally friendly and capable of generating high output power with low electric power. Furthermore, the light-emitting diode 54 is small in size, lightweight and structurally simple, which makes it easy to mount the same to each of the temples 14 in a built-in fashion. Moreover, the light-emitting diode 54 shows reduced light loss, while exhibiting enhanced visibility and directivity, and therefore can be advantageously used in night fishing, night mountain climbing and other like applications. In addition, the light-emitting diode 54 provides illumination suitable for enabling a user of convex eyeglasses to perform working and reading.

Shown in FIG. 7 is another example of the cable connecting structure employed in the eyeglasses of the first embodiment. Referring to FIG. 7, a socket 90 is attached to the rear surface of the sheath 22. The socket is connected to the lamps 50 through the resistors 56. The cable 60 is provided with a jack 92 at one end thereof. The jack 92 is coupled to the socket 90 so that electric power can be supplied therethrough to turn on the lamps 50. The cable 60 can be detached from the corresponding one of the temples 14 by decoupling the jack 92 from the socket 90. This enables the user to easily wear the eyeglasses 1 without having to use the cable 60, particularly in a place requiring no illustration.

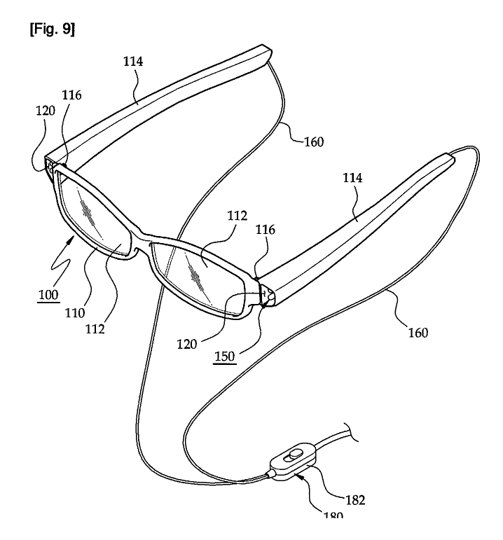

Shown in FIGS. 8 through 12 are eyeglasses with an illumination function in accordance with a second embodiment of the present invention. Referring to FIGS. 8 and 9, the eyeglasses 100 of the second embodiment include a frame 110, a pair of lenses 112, a pair of temples 114 and a pair of hinges 116, just like the eyeglasses 1 of the first embodiment. Although the temples 114 employed in the eyeglasses 100 of the second embodiment have no rear curved tip portion engaging with the ears, it may be possible for the temples 114 to have rear curved tip portions as in the eyeglasses 1 of the first embodiment.

Referring to FIGS. 8 through 11, each of the temples 114 is of a hollow type having a forwardly opened receiving pocket 120 at its front end and an elongated bore 122 extending from the receiving pocket 120 to the rear end of each of the temples 114. The bore 122 terminates at a rear wiring hole 124 through which a cable 160 passes. A shoulder 126 is formed within the receiving pocket 120. The eyeglasses 100 of the second embodiment further include holders 130 each received within the receiving pocket 120 of each of the temples 114. Each of the holders 130 is supported at its rear peripheral edge by the shoulder 126 and is accurately self-aligned within the receiving pocket 120. A plurality of fixing recesses 132 is formed on the front surface of each of the holders 130. Each of the fixing recesses 40 terminates at a downwardly backwardly inclined support surface 134 on which a plurality of wiring holes 136 is formed.

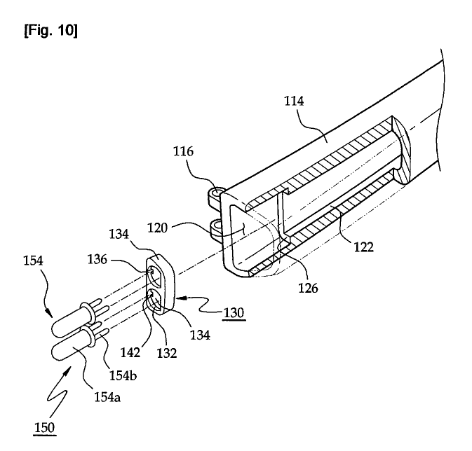

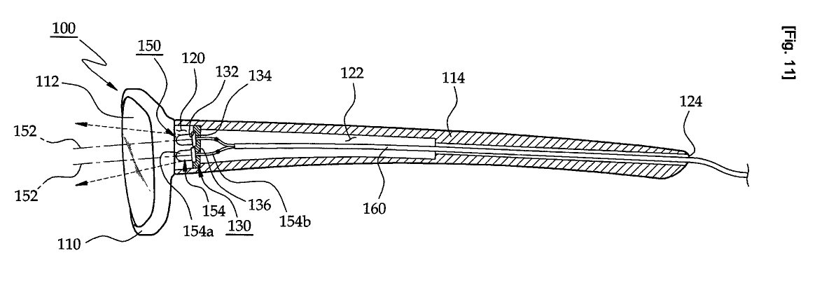

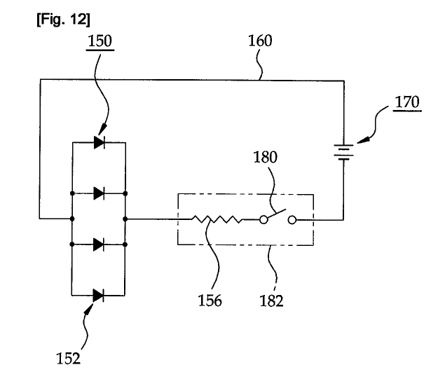

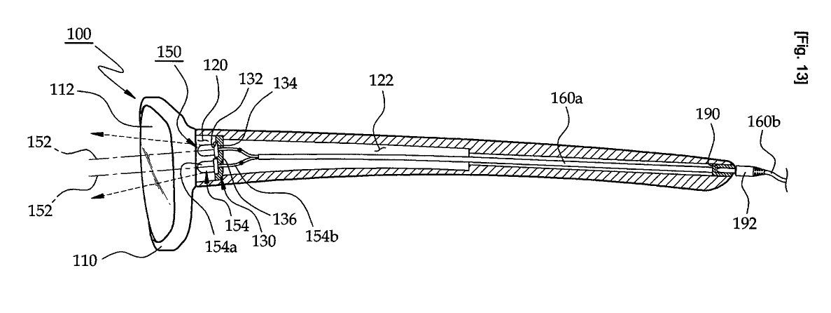

As shown in FIGS. 10 and 12, the eyeglasses 100 of the second embodiment further include a plurality of lamps 150 mounted to the receiving pocket 120. Each of the lamps 150 has a light axis 152 extending parallel to the line of sight of the user. Each of the lamps 150 is formed of a light-emitting diode 154 which consists of a body portion 154a for emitting light when energized and a plurality of leads 154b connected to the body portion 154a. If necessary, the lamps 150 may be directly inserted into the receiving pocket 120 of each of the temples 114 with no use of the holders 130. In this case, a structure for ensuring that the light axis 152 of each of the lamps 150 extends forwardly and downwardly needs to be provided inside the receiving pocket 120.

The lamps 150 are connected to a power source 170 by means of the cable 160 extending through the bore 122 and the wiring hole 124 of each of the temples 114. The cable 160 is soldered to the lamps 150 at its one end. The power source 170 is formed of a battery pack 172. As shown in FIG. 8, the battery pack 172 includes a case 172a, a cover 172b for covering the case 172a and a plurality of batteries 172c received within the case 172a. If necessary, the cable 160 and the battery pack 172 may be connected to each other using a connector. As with the eyeglasses 1 of the first embodiment, the power source 170 may be a mobile terminal. Likewise, the battery pack 172 may be employed in the eyeglasses 1 of the first embodiment. As shown in FIGS. 8 and 12, a switch 180 for on-off controlling the supply of electric power is arranged in the cable 160 extending between the frame 110 and the power source 170. A resistor 156 is received within a case 182 of the switch 180. If necessary, this construction may be applied to the eyeglasses 1 of the first embodiment.

With the eyeglasses 100 of the second embodiment constructed as above, the lamps 150 emit light when energized. The light thus emitted is projected forwards parallel to the line of sight of the user. Since the cable 160 extends toward the power source 170 through the bore 122 of each of the temples 114, it is possible to minimize the length of the cable 160 exposed between each of the temples 114 and the power source 170. The cable 160 extends from each of the temples 114 through the wiring hole 136 formed at the rear end of each of the temples 114. Then, the cable 160 is naturally suspended and arranged in the backside of each ear of the user. This eliminates the possibility that the cable 160 comes into contact with the face of the user or obstructs the field of view of the user.

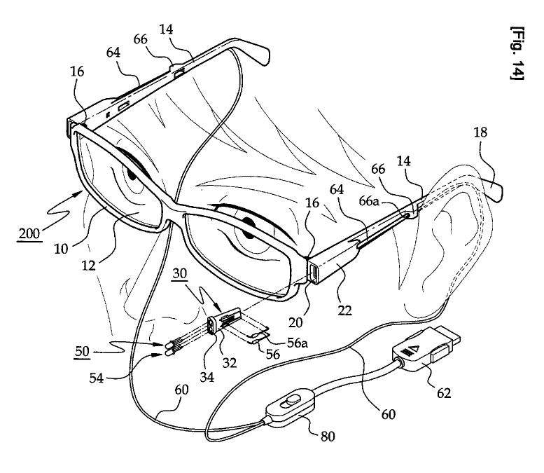

FIG. 13 shows another example of the cable connecting structure employed in the eyeglasses 100 of the second embodiment. Referring to FIG. 13, a socket 190 is attached to the rear end of each of the temples 114. The socket 190 is electrically connected to the lamps 150 by means of an internal cable 160a. A jack 192 that can be inserted into the socket 190 is attached to one end of an external cable 160b. The lamps 150 are turned on if electric power is supplied thereto in a state that the jack 192 is inserted into the socket 190. When there is no need to perform illumination, the external cable 160b may be removed from each of the temples 114 so that the user can wear the eyeglasses 100 in an easy and convenient manner.

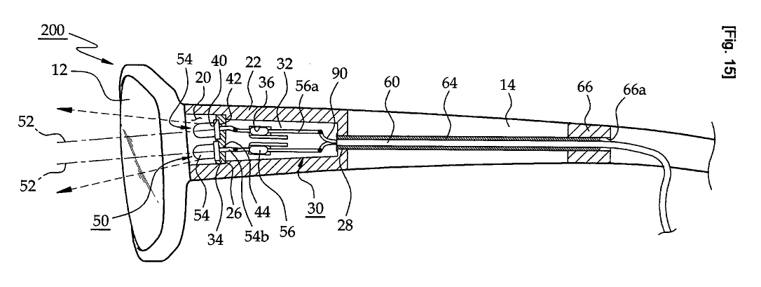

FIGS. 14 and 15 shows eyeglasses with an illumination function in accordance with a third embodiment of the present invention. The eyeglasses 200 of the third embodiment have essentially the same construction as the eyeglasses 1 of the first embodiment described above. Therefore, like reference numerals are used to designate the same parts, with no detailed description made in that regard.

The eyeglasses 200 of the third embodiment include a wiring pipe 64 for receiving and hiding the cable 60. The wiring pipe 64 is fixedly secured to an outer lateral surface of each of the temples 14 and extends in a longitudinal direction thereof. The wiring pipe 64 is inserted at one end into the wiring hole 28 of the sheath 22 and positioned near each ear of the user at the other end. A fixing protrusion 66 is integrally formed with each of the temples 14 in a position near each ear of the user. The fixing protrusion 66 has a hole 66a to which the other end of the wiring pipe 64 is fitted.

The cable 60 is connected to the power source 70 through the wiring hole 28 of the sheath 22, the wiring pipe 64 and the hole 66a of the fixing protrusion 66. The cable 60 is exposed to the outside as it extends beyond the hole 66a of the fixing protrusion 66. The cable 60 thus exposed extends over each ear of the user in a backward direction. This eliminates the possibility that the cable 60 comes into contact with the face of the user or obstructs the field of view of the user. Although the cable 60 extends over each ear of the user in the embodiment shown in FIG. 14, it may be possible for the user to wear the eyeglasses 200 in a state that the cable 60 is suspended in front of each ear of the user.

The embodiments set forth hereinabove have been presented for illustrative purpose only and, therefore, the present invention is not limited to these embodiments. It will be understood by those skilled in the art that various changes and modifications may be made without departing from the scope of the invention defined in the claims.

### INDUSTRIAL APPLICABILITY

With the eyeglasses with an illumination function described above, the lamps mounted to the front end portions of the temples can perform illumination in the direction parallel to the line of sight of the user, thereby assuring increased visibility. Thus, it is possible for the user to effectively use the eyeglasses at night or in dark places and free from restraints in activity. Furthermore, since the lamps are built in the front end portion of each of the temples, the eyeglasses are structurally simple, small-sized and lightweight while providing an improved illumination function. In addition, the eyeglasses are convenient to use because the lamps can be easily connected to a separate power source such as a mobile terminal, a battery pack or the like.

1. Eyeglasses with an illumination function, comprising:
a frame having a pair of lenses mounted thereto;
a pair of temples collapsibly attached to the frame in a spaced-apart relationship with each other, each of the temples having a front end portion hingedly secured the frame, a rear end portion extending over each ear of a user and a forwardly opened receiving pocket formed in the front end portion;
a plurality of lamps received in the receiving pocket of each of the temples for emitting light forwards; and
a power source provided independently of the frame and selectively connectable to the lamps via a cable.

2. The eyeglasses as recited in claim 1, wherein the each of the lamps has a light axis extending forwardly and downwardly in a generally parallel relationship with a line of sight of the user.

3. The eyeglasses as recited in claim 2, further comprising a holder fitted into the receiving pocket, the holder having a plurality of fixing grooves formed on its front surface to receive the lamps, each of the fixing grooves terminating at an inclined support surface for supporting each of the lamps in a downwardly inclined state.

4. The eyeglasses as recited in claim 3, wherein the holder has a mounting plate portion fitted into the receiving pocket and a flange formed at a front end of the mounting plate portion, the fixing grooves being formed near the flange, the mounting plate portion having a plurality of fixing holes to which a plurality of resistors is fixed, each of the resistors being connected to each of the lamps.

5. The eyeglasses as recited in claim 4, wherein the mounting plate portion has a snap hook formed on one side thereof, each of the temples having a locking hole with which the snap hook engages.

6. The eyeglasses as recited in claim 1, further comprising a switch arranged in the cable extending between the receiving pocket and the power source for on-off controlling electric power supplied from the power source to the lamps, the power source including a battery pack.

7. The eyeglasses as recited in claim 1, further comprising a wiring pipe attached to an outer lateral surface of each of the temples for receiving a part of the cable, the wiring pipe extending in a longitudinal direction of each of the temples.

8. The eyeglasses as recited in claim 7, wherein each of the temples has a sheath formed on the outer lateral surface thereof for defining the receiving pocket and a fixing protrusion formed on the outer lateral surface of each of the temples in a spaced-apart relationship with the sheath, the wiring pipe being arranged between the sheath and the fixing protrusion.

9. The eyeglasses as recited in claim 1, wherein each of the temples is of a hollow type having a longitudinally extending bore for receiving a part of the cable, the bore communicating with the receiving pocket so that the cable can extend from the receiving pocket to the power source through the bore.

10. The eyeglasses as recited in claim 9, further comprising a switch arranged in the cable extending between the receiving pocket and the power source for on-off controlling electric power supplied from the power source to the lamps, the power source including a mobile terminal.

11. The eyeglasses as recited in claim 1, further comprising a socket attached to each of the temples and electrically connected to the lamps, the cable having a jack removably coupled to the socket.
